(19) United States
(12) Patent Application Publication
(10) Pub. No.: US 2025/0377900 A1
(43) Pub. Date: Dec. 11, 2025

(54) INTEGRATED CIRCUIT WITH INTEGRATED INFORMATION SYSTEM FOR SIMPLIFIED INTERACTIVE PROGRAMMING BY MULTI-AGENT SYSTEM

(71) Applicant: Valère Fontaine-Picoureix, Montreuil (FR)

(72) Inventor: Valère Fontaine-Picoureix, Montreuil (FR)

(21) Appl. No.: 19/301,167

(22) Filed: Aug. 15, 2025

Related U.S. Application Data
(63) Continuation of application No. PCT/EP2024/053733, filed on Feb. 14, 2024.

(30) Foreign Application Priority Data
Feb. 15, 2023 (FR) 2301419

(51) Int. Cl. G06F 9/4401; G06F 8/34

(52) U.S. Cl. CPC G06F 9/4403; G06F 8/34

(57) ABSTRACT

A method for programming an integrated circuit comprising one or more microprocessors, at least one random-access memory, at least one read-only memory and at least one non-volatile rewritable memory, at least one high-speed bus and one bus, and functional components, wherein a step of recording, in the non-volatile rewritable memory, a set of executable computer codes is carried out, the method comprising booting steps according to an execution mode or according to a programming mode comprising: ⋅an original step of recording, in a non-erasable mass memory of the integrated circuit during the manufacture of the integrated circuit: ⋅a set of static resources comprising the digital development tools forming an assisted development environment executable by a browser and the technical documentation relating to the programming of the integrated circuit; ⋅and a boot code according to a programming mode; ⋅wherein the booting step according to the programming mode consists in controlling: ⋅querying the state of the hardware and software dynamic resources of the integrated circuit and a step of recording, in a local rewritable memory, the state for each of the hardware and software resources; ⋅activating the transfer of the static resources and the dynamic resources to a connected external computer device.

### CROSS-REFERENCE TO RELATED APPLICATIONS

Pursuant to 35 U.S.C. § 111(a), this application is a continuation of International Patent Application PCT/EP2024/053733, filed Feb. 14, 2024, and titled “Integrated Circuit with Integrated Information System for Simplified Interactive Programming by Multi-Agent System,” which claims the benefit of French Patent Application Serial No. FR 2301419, filed Feb. 15, 2023, the disclosure of each of which is hereby incorporated herein in its entirety by this reference.

### TECHNICAL FIELD

The present disclosure relates to the field of electronic circuits, and more particularly to the control of microprocessor integrated circuits. A microcontroller is an example of a programmable integrated circuit comprising, in addition to one or more microprocessors, memories (flash, ROM, EEPROM, RAM, OTP, etc.), interface and signal processing peripherals, etc. On startup, a microcontroller executes a boot program, consisting of code instructions suitable for being executed by a microprocessor. Such a boot program is recorded in a non-volatile memory, such as ROM (read-only memory), and makes it possible to launch by default the execution of a more complex general program, often referred to as an “application,” designed to perform certain tasks by using the various functions of the microcontroller. Particularly in embedded systems, the microcontroller can also be configured to run a program for loading a specific program. In particular, the specific program makes it possible to modify the general program by modifying the content of a non-volatile memory in which all or part of the general program is recorded.

The microcontroller is arranged so as to execute an operating program that is contained in the ROM and comprises functional parts each defining a function of the processing unit. The data used by the microcontroller are generally contained in the programmable read-only memory (ROM), while the operating program is recorded in the ROM when the integrated circuit is manufactured, and cannot be modified thereafter. Improving the operating program, and any modification thereto in general, therefore requires the manufacture of new integrated circuits.

### BACKGROUND

In the prior art, European Patent EP2252978 describes an integrated circuit comprising a processing unit associated with a ROM and a programmable ROM, the ROM containing an operating program executable by the processing unit and comprising functional parts that each define a function of the processing unit. The program has an input/output point for each functional part, and an identifier is associated with each functional part. The programmable ROM contains at least one functional part that can be substituted for one of the functional parts of the ROM and is associated with an identifier corresponding to that of the corresponding functional part of the ROM. The processing unit is arranged so as to execute the substitutable functional part in place of the corresponding functional part of the ROM. The input/output points of the operating program are thus arranged between each functional part, so that the processing unit can bypass an original functional part of the operating program by executing in its place a substitutable functional part recorded in the programmable read-only memory. In addition, the multiplicity of input/output points for the operating program makes it possible to limit the size of the program components making up the substitutable functional parts recorded in the programmable read-only memory to the size of the functional parts to be replaced. This means that the programmable read-only memory takes up relatively little space due to the substitutable functional parts.

These substitutable functional parts can be recorded in the programmable read-only memory not only by the manufacturer of the integrated circuit, but also by the card issuer, thereby simplifying management. Advantageously, the substitutable functional part is loaded into a start zone of the programmable read-only memory. This makes it possible to speed up the search for substitutable functional parts, so that execution of the operating program is not slowed down to a detrimental degree. Preferably, the programmable read-only memory comprises a substitutable functional part presence indicator. In this way, the processing unit can quickly detect whether it is necessary to read the programmable read-only memory in search of a substitutable functional part.

Generally speaking, integrated circuits require the development of a computer program consisting of lines of code written in a specific language recognized by the processor of the integrated circuit. “ASSEMBLER” programming languages have long been known, the mnemonics of which are symbols representing the instruction set for a given processor, in order to allow the programming thereof. Assembler is referred to as a “low-level language,” because it is close to the language of the machine in question, which is made up of binary words consisting of a sequence of 1s and 0s. The lines of code can then be directly executed by the microcontroller, but developing such a program is a highly technical and even daunting task.

There are also what are called “high-level” programming languages such as BASIC, FROTRAN, PASCAL, ANSI C, etc., which, unlike assembler, make it possible to abstract from the instruction set for a given processor, microprocessor or microcontroller.

These languages allow humans to write programs using a syntax that they can understand (often borrowed from English), and then translate the written program (the source code) into a language that can be understood by a given type of machine (a binary file made up of a sequence of 1s and 0s).

The operation of translating human-understandable language into machine-understandable language is called “compilation.” There are compilers that can translate the same high-level program source code into multiple “machine languages,” depending on the targeted processor (cross-compilers).

Software “libraries” are also known, which are considered to be “program building blocks” capable of performing all kinds of generic or specific actions that can prove complex, such as the use of certain peripherals (camera, sensors, etc.). In this way, the designer benefits from the use of ready-to-use “software components” to maximize their time in concentrating on the specifics of their program code.

Assembler programming depends on the prior choice of processor, while programming in high-level languages (such as Basic, Pascal, C, C++, etc.) depends on the presence of the compiler required for the intended target.

When the target is not a simple sequentially programmable microprocessor, but is already configured to provide advanced functions (such as integrated circuits specialized for complex tasks, or “MCUs”), it is essential to study this type of hardware beforehand so as to be able to use their functions either by programming their registers directly, or by doing so through libraries that facilitate their implementation.

Before being able to program an integrated circuit, a familiarization step is essential: the operator must first study a datasheet or technical reference manual, which comprises several hundred or even several thousand pages that must be read with care. This can take a considerable amount of time, especially if the operator has never worked with the integrated circuit in question before.

After studying the technical manual, the operator will be able to identify the resources of the integrated circuit that meet the needs of their project. The operator must then identify the right registers to configure the desired resources. Each of the useful registers must be configured according to the technical manual, by writing an operating program for the specialized integrated circuit.

The next step is to install and become familiar with the software suite and tools needed to enter the program code, download it to the integrated circuit, and finally test and debug its functionalities. This toolchain is often referred to by the generic term integrated development environment (IDE), where the toolchain is integrated and accessible from a single user interface.

It is clear that all of these steps prior to programming are inarguably complex, and waste considerable time and energy, depending on the nature of the project and the complexity of the required integrated circuit. (An example is the Texas Instruments “AM243x” MCU, which requires a 9305-page technical manual to be studied in order to learn how to program the thousands of registers of this chip.)

All this surrounding complexity alone accounts for two-thirds of the effort invested, whereas most of the added value and know-how resides in programming, which is the main task. Ideally, therefore, the operator should be able to devote most of their time and energy to this, with everything else being secondary and taking up only a negligible part of their time. To achieve this, there is a need to simplify the user interface, simplify the development environment and, above all, rethink programming methods that have remained unchanged for over 50 years.

Considering, for example, an environment for experimenting with and programming dedicated integrated circuits, it would be highly advantageous to have their functions and register parameters accessible within a high-level interactive language, and embedded intelligence designed to implement them instantaneously, thereby avoiding all the current complexity.

Ultimately, even if a user knows the one or more functions of an integrated circuit without knowing its datasheet, it is currently still impossible for them to implement it.

The use of an integrated circuit of the prior art therefore requires a high level of technical expertise, at the expense of a costly investment in energy and time, the associated documentation needed to make use of the functionalities of the integrated circuit, and finally a suite of complex hardware and software tools (toolchain) to connect to it, experiment with it, program it, debug it and ultimately obtain a usable result.

### BRIEF SUMMARY

In order to overcome these drawbacks, the present disclosure relates, in its most general sense, to an integrated circuit (IC) or “chip.” This programmable integrated circuit fundamentally differs from any other known integrated circuit in the incorporation, within the very core of its architecture, of: intelligent agents, an information system, and an “agent-assisted interactive programming environment” (AAIPE). The agents include slave agents arranged between the registers of the chip and the network of the information system in charge of informing a master agent, which controls the chip by means of instructions entered by a human operator using the “AAIPE,” or instructions, prerecorded in a file, which will be read for execution, or lastly depending on the bias on the pins/pads of the integrated circuit. Some agents comprise an integrated artificial intelligence device.

The present disclosure relates, in particular, to a method for programming an integrated circuit.

The integrated circuit for implementing this method comprises one or more microprocessors, at least one random-access memory, at least one read-only memory and at least one non-volatile rewritable memory, at least one high-speed bus and one bus, and functional components, consisting in recording, in the non-volatile rewritable memory, a set of executable computer codes. The method comprises:
a. An initial step, activated by powering up the integrated circuit, of querying all of the hardware and software resources of the integrated circuit, and recording, in a local database, for each of the resources:
at least one numerical descriptor for each of the resources, and
a list of simplified programming commands for each of the resources;
b. A step of selecting between an execution or programming mode.
In the case of the programming mode being selected:
I. Transmission, to a connected terminal, of a web application executable by the browser of the terminal, the web application containing:
technical documentation and the specifications for the integrated circuit, and
a specific programming software suite for the integrated circuit.
II. Transmission, by the connected terminal, of the list of simplified programming commands for each of the resources.
In the case of the execution mode being selected, loading a system configuration file recorded in the non-volatile memory consisting of a list of interpretable commands, the presence of each of the commands in the local database being checked in order to be compiled and executed on the fly.

According to one variant, the initial step further comprises reading the pin state of the integrated circuit in order to determine a “master” or “slave” mode, and, in the case of the master mode, collecting the contents of the local databases of the interconnected “slave” integrated circuits.

The present disclosure also relates to an integrated circuit comprising one or more microprocessors, at least one random-access memory, at least one read-only memory and at least one non-volatile rewritable memory, at least one high-speed bus and one bus, and functional components, wherein the integrated circuit further comprises:
A plurality of agents each consisting of a computer each comprising a processor, an artificial intelligence accelerator microprocessor, a read-only memory, a non-volatile memory, a random-access memory, a router and a plurality of interfaces for data exchange;
A bus for data exchange between the agents;
One of the agents being an information agent-R comprising:
an interface for direct access to the RAM, and
an interface for data exchange with a bus,
Others of the agents being simplifying agents-S comprising:
an interface for data exchange via the bus with the plurality of agents, and
an interface for data exchange with each of the functional components and for data exchange with a software application,.
One of the agents being a master agent-M:
an interface for data exchange via the bus with the plurality of agents, and
an interface for data exchange with a connected peripheral terminal and for accessing the programs and data recorded in the rewritable non-volatile memory.

Advantageously, the integrated circuit further comprises configuration pins for controlling the state of the information agent-R by applying a voltage.

Preferably, it further comprises a non-volatile memory containing:
a first microcode, the execution of which controls the search, collection, processing and storage of data relating to each subassembly of the integrated circuit;
the first microcode automatically generating requests routed to internal components via at least one bidirectional configuration bus,
these requests triggering responses by the internal components and peripherals that are available and operational in the integrated circuit, the responses being processed in order to construct a database identifying the internal resources and peripherals and listing their respective commands in the database, and
the execution of the first microcode being controlled during startup (BIOS) by writing, into a register in the boot read-only memory, a code defined by the polarity of one or more external pins dedicated to the initial configuration (Boot).

Advantageously, the boot read-only memory further comprises a register the state of which indicates whether the MCU is designated as master or slave, depending on the polarity of one or more external pins dedicated to the initial configuration (Boot).

Preferably, the subassemblies of the integrated circuit are associated with an autonomous agent comprising ROM, FLASH and RAM memories, a microprocessor, and an input/output interface, a natural language microinterpreter, and a table containing the attributes and functionalities of the subassembly.

According to another variant, the non-volatile memory further comprises a second microcode controlling the querying of the communication buses for the presence of one or more slave additional integrated circuits and, where applicable, searching for and importing the command tables for each of the slave integrated circuits, and recording, in a second command table, the second command interpreter microcode ensuring, in response to a natural language request transmitted either by the remote terminal, the querying of the local command table and, failing that, the querying of the second command table, in order to ensure the configuration of the registers associated with the function corresponding to the interpreted command, according to the arguments of the request, where applicable.

Advantageously, the database comprises information coded in natural language and communicates with the communication interface on the one hand, and a binary code interpreter executing the actions ordered by the instructions in the language on the other.

Advantageously, the database comprises an information system associated with an information agent, a subnetwork management agent comprising a packet communication network connecting a plurality of intelligent agents, each interfaced to their subassemblies, a master agent for configuring the integrated circuit and its application program, a reconfigurable multilayer network controlled by an agent, and an interactive programming environment assisted by the master agent.

### BRIEF DESCRIPTION OF THE DRAWINGS

The present disclosure will be better understood from reading the following description, which relates to a non-limiting exemplary embodiment illustrated by the accompanying drawings, in which:

FIG. 1 schematically shows the hardware architecture of the integrated circuit (950) according to one example of the present disclosure;

FIG. 2 schematically shows the hardware architecture of the integrated circuit (1000) according to a more developed version of the present disclosure;

FIG. 3A schematically shows the hardware architecture of the master agent (500), referred to as the “system management agent”;

FIG. 3B schematically shows the hardware architecture of a simplifying agent;

FIG. 3C schematically shows the hardware architecture of the information agent (250);

FIG. 4 schematically shows the functional architecture of the integrated circuit (1000) according to the present disclosure; and

FIG. 5 schematically shows, specific to the invention, the housing (1100) of the integrated circuit (1000) according to one exemplary embodiment.

### DETAILED DESCRIPTION

The present disclosure relates to the incorporation, into the integrated circuit (1000), of the digital resources required for the programming thereof, these resources being downloadable onto the external computer device in order to allow the use thereof on this external device.

These resources (100, 220, 230, 10, 20, 410, 530, 540, 550, 560) and software (420) comprise both static and dynamic information.

A. Static information is recorded in a non-volatile mass memory that retains the recorded information even in the absence of a power supply, typically a flash memory. They comprise an assisted development environment comprising the browser-executable digital development tools and technical documentation relating to the programming of the integrated circuit (1000), which is usually supplied to developers in the form of a written or digital manual, with the disadvantage that this documentation has to be updated each time the integrated circuits in question evolve, and that the developer has to check the conformity of the documentation available to them with the integrated circuit (1000) that they plan to program. The present disclosure provides a radical solution to this problem in that the integrated circuit (1000) natively integrates, by manufacture, its own documentation, which is therefore necessarily up to date and suited to the version of the integrated circuit (1000) in question. As such, there is no risk of a mismatch between the integrated circuit (1000) and the documentation available to the developer, nor of this documentation being unavailable when programming of an integrated circuit (1000) begins. This static information forms a set of digital data referred to in this disclosure as the “assisted programming environment” AAIPE (800). This “assisted programming environment” AAIPE (800) groups together all of the tools required to meet the needs of the operator from the first steps-advantageously including all or some of the programming, simulation, debugging, and complete hardware measurement and self-test functionalities-right through to the final functional result. The system files (810) for this environment are recorded in flash memory (220). The AAIPE (800) also preferably comprises a human-machine interface (820) referred to as a graphical user interface (GUI) displayed by a terminal (900) connected to the communication interface (340).

B. The dynamic information is recorded in a rewritable random-access memory and is processed by the integrated circuit (1000) episodically, and describes the state of the hardware and software resources of the integrated circuit (1000), and optionally of its environment, when the integrated circuit (1000) is interconnected with other computer components. The preparation of this dynamic information is controlled by a process executed by computer code recorded in RAM memory.

C. Finally, the integrated circuit (1000) according to the present disclosure comprises a circuit for communication with an external computer device, on the one hand for transferring the aforementioned static information and dynamic information to the external computer device, and on the other hand for transferring digital programming files for the integrated circuit (1000), which have been prepared on the external computer device on the basis of the static, dynamic information and the processing carried out by the developer.

Another distinguishing feature of an integrated circuit according to the present disclosure is the boot mode.

For an integrated circuit of the prior art, the processor is generally initialized so as to begin executing a boot code; the boot code instructions are recorded, for example, starting at the address 0xFFFF:0000h (the maximum address in real memory minus 16 bytes). This is where a boot code, usually called BIOS, will be found. The BIOS runs and initializes the integrated circuit before handing over to a more elaborate code recorded in EEPROM.

The integrated circuit (1000) according to the present disclosure is distinguished in its operation by two boot modes, one corresponding to the usual boot mode, known for the integrated circuits of the prior art, the other corresponding to a programming mode specific to the invention. This second mode is activated:
a. automatically on first use and generally when the integrated circuit has not yet been programmed,
b. when a physical action is applied to the integrated circuit (1000), e.g., by biasing ports (strapping pins) of the integrated circuit (1000), i.e., by applying signals to the ports, which will be interpreted by the microcontroller as a command to activate the programming mode.

This second boot mode activates the execution of a code recorded in a flash memory, controlling the recording of the aforementioned static and dynamic information in a rewritable memory, and the transfer of these data to an external device via the aforementioned communication circuit. To this end, this code controls the dynamic information collection process and the communication protocol, or activates a code controlling the communication layer.

In summary, the present disclosure relates to a “stand-alone” integrated circuit configured to be programmed on its own, i.e., without technical documentation or additional knowledge, and the startup of which includes an optional mode controlling the automatic export, to an external computer device, of all static and contextual information required by a developer to program it, before transferring the digital files developed on the external computer device from this device in order to program the printed circuit for new functionalities, in full compliance with the type of integrated circuit (1000) and the state of its internal hardware resources and, optionally, its digital environment.

From a hardware architecture point of view, the integrated circuit conventionally comprises one or more microprocessors (100), at least one random-access memory (230), at least one read-only memory (200) and at least one rewritable non-volatile memory (220), at least one high-speed bus (10) and one bus (20), and functional components (530, 540, 550, 560), consisting in recording, in the rewritable non-volatile memory (220), a set of executable computer codes.

The integrated circuit according to the present disclosure is also distinguished from the prior art by the incorporation of a mass memory for recording its technical documentation at the time of manufacture, for example, by flashing, and by a wireless (optical, radiofrequency) or wired communication circuit via one pad of the integrated circuit, with an external computer device for the bidirectional transfer of digital files between the integrated circuit and the external computer device.

To facilitate reading of the descriptions that follow and avoid redundant details, the following glossary is a reference for terms attributed to the basic devices that make up the present disclosure:

### 1—System on a Chip or “SOC” and Microcontroller or “MCU”

A system on a chip (SOC) is an integrated circuit (IC) in which all of the components of a complex VLSI (very large scale integration) electronic system are integrated. Typically, this integrated circuit comprises, by way of non-limiting example, digital functions, analog functions, mixed signal functions and radiofrequency functions, brought together by photolithography on a single substrate (e.g., silicon) to form a “monolithic integrated circuit.” Alternatively, these functions can take the form of separate “dies” that are bonded and connected to a substrate to form a “hybrid integrated circuit.”

Typically, the integrated circuit comprises hardware (e.g., a microprocessor, microcontroller, logic circuits, memories, etc.), but also software to control its functionality and implement an application on its hardware.

In modern terminology, a microcontroller (or MCU for microcontroller unit) is similar to, but less sophisticated than, an SOC, which can integrate more advanced peripherals, such as a graphics processing unit (GPU), Wi-Fi radio interface, Ethernet interface, etc. However, systems on a chip and microcontrollers are intended for embedded applications, unlike computer microprocessors where each functionality is found in separate chips.

### 2—Information System (IS)

According to the present disclosure, “the information system” is an independent device made up of a processor (CPU) running an autonomous program recorded in a dedicated memory, which collects, stores, structures, models, manages, manipulates, analyzes, transports, exchanges and disseminates information.

Such information systems frequently operate within companies. They are usually described as “a set of computing devices and resources” designed to perform all of the tasks listed above.

For the purposes of the present disclosure, such an information system is miniaturized to the extreme so that it can be implemented within an integrated circuit, in order to reproduce tasks identical to those listed above, in order to help simplify and speed up the programming of the integrated circuit by the human operator, according to the present disclosure.

### 3—Agent and Intelligent Agent

According to the present disclosure, “an agent” comprises a computer made up of dedicated ROM, RAM and flash memories, CPU and NPU. This computer executes an independent program code (software), active in background tasks, capable of autonomous operations, able to perform complex operations on behalf of an authority (which may be another software program, a computer file containing prerecorded commands, the bias of the pins/pads of the integrated circuit, or a human operator), and does so through interactive communication with its environment, via a common ACL (agent communication language).

To dialog via a language, the agent has an “interpreter device” made up of a lexical analyzer, a parser, a keyword dictionary, a translator, an interpreter and an on-the-fly compiler. (Lexical analysis operates on the individual characters of the input, while parsing operates on the stream of lexemes generated by the lexical analysis.)

According to a method specific to the present disclosure, the compiler generates binary code intended for programming the registers of a microprocessor peripheral microcircuit, whereas the binary code usually generated is machine language intended for the microprocessor itself.

According to the present disclosure, this difference fundamentally distinguishes an interpreter of an agent from an interpreter embedded in a microcontroller (such as MCS-51 Basic in the INTEL 8051 or, today, MicroPython in an ARM M4F).

Furthermore, an “intelligent agent” perceives the context in which it operates, takes autonomous action to achieve objectives while integrating constraints, and can improve its performance through learning and the use of knowledge and models.

Such agents and intelligent agents usually operate in the context of networked web applications, or artificial intelligence devices for computers.

For the purposes of the present disclosure, such agents and their hardware resources are miniaturized so that they can be integrated into the architecture of a microscopic integrated circuit, in order to reproduce tasks identical to those described above, in order to help simplify and speed up the programming of the integrated circuit by the human operator, according to the present disclosure.

The present disclosure has defined at least three categories of intelligent agents:
1. the information agent operating the information system, or “agent-R”
2. the system-on-a-chip (SOC) agent, or “master agent,” or “agent-M”
3. simplifying agents, or “agent-S” for short

### 4—Networked multi-agent system, or “MAS”

According to the present disclosure, a “multi-agent system” refers to an organized set of agents as defined in the preceding paragraph. There may be one or more organizations structuring the rules of collective tasks between agents. An agent can belong to several organizations. The agents are peripherals of a dedicated network on a chip (NOC). They communicate with one another via packets, using a common language (ACL), either by sharing information via the environment (indirect communication), or by exchanging messages (direct communication). The agent can take part in a dialog either passively or actively. A “passive agent” must accept and answer questions from other agents, while an “active agent” must propose and send queries. In a dialog, agents alternate between active and passive roles, and their message exchanges follow precise protocols, namely: (1) coordination protocol, (2) cooperation protocol, (3) negotiation protocol.

Such “MASs” are typically implemented in networked communication infrastructures, for example, in local, metropolitan or wide-area wireless networks.

For the purposes of the present disclosure, such a networked MAS is miniaturized so that it can be integrated into the architecture of a microscopic integrated circuit, in order to reproduce processes conforming to those described above, in order to help simplify and speed up the programming of the integrated circuit by the human operator, according to the present disclosure.

### 5—Assisted Interactive Programming Environment (AIPE)

According to the present disclosure, “assisted interactive programming environment” or “AIPE” designates a set of resources and software, used simultaneously, for learning, programming, debugging and commissioning the integrated circuit once completed. The resources of the AIPE consist of technical documentation. The software suite is made up of a console, a multi-language programming editor, a script interpreter and its on-the-fly compiler, a source code compiler, a JTAG probe and a memory programmer. According to the present disclosure, intelligent agents, such as those described above, assist in the operation of the software suite, to guide the operator in entering their instructions, but can also ask them questions in human language to help them make their choices. The aim is to simplify and speed up the task of programming the integrated circuit.

Such a programming environment is usually referred to as an “IDE” (integrated development environment). An IDE is usually intended to be installed on host computers, referred to in this context as “workstations” by developers. The workstation hosting the software suite will then be connected by cable or radio to the board hosting the integrated circuit to be programmed by the operator.

For the purposes of the present disclosure, such an IDE is miniaturized for integration into the architecture of a microscopic integrated circuit, in order to offer resources and functionalities identical to those described above, in order to help simplify and speed up the programming of the integrated circuit by the human operator, according to the present disclosure.

### 6—Integrated Circuit Subassemblies or “Components”

According to the present disclosure, “integrated circuit subassemblies” refers to the microcircuits (e.g., in the form of dies bonded to the silicon substrate of a “hybrid SOC,” or etched onto the same silicon substrate in a “monolithic SOC”) that are components of the internal architecture, such as its peripherals, interfaces, memories, measuring devices, microprocessors, etc. The program codes associated with these components are also considered to be “software subassemblies” of the integrated circuit.

### 7—Reconfigurable Multilayer Network

According to the present disclosure, “switchable multilayer network” refers to at least two serial data transmission networks that are superimposed and connected to the same peripherals. Every network has a software layer (session, transport) and a hardware layer (packet, frame, network). Each layer can interconnect certain peripherals while ignoring others. The layers can be interconnected in order to exchange data, or separate in order to isolate data. According to the present disclosure, the different configurations are operated by an agent-S.

The following detailed descriptions of non-limiting exemplary embodiments refer to the above glossary for all relevant terms.

### Hardware Architecture

According to one non-limiting example, the present disclosure relates to an integrated circuit comprising a microcontroller unit (MCU) or a system on a chip (SOC) (1000) dedicated to a function, for example, facial recognition, audio stream processing, video stream processing, information processing, etc., and comprising one or more microprocessors (100), random-access memory (230) and non-volatile rewritable memory (220), and a plurality of peripherals (550) (e.g., interface, signal generation and processing, etc.), as well as at least one communication interface (340) (Ethernet, USB, Wi-Fi, etc.), and at least one configuration bus (580).

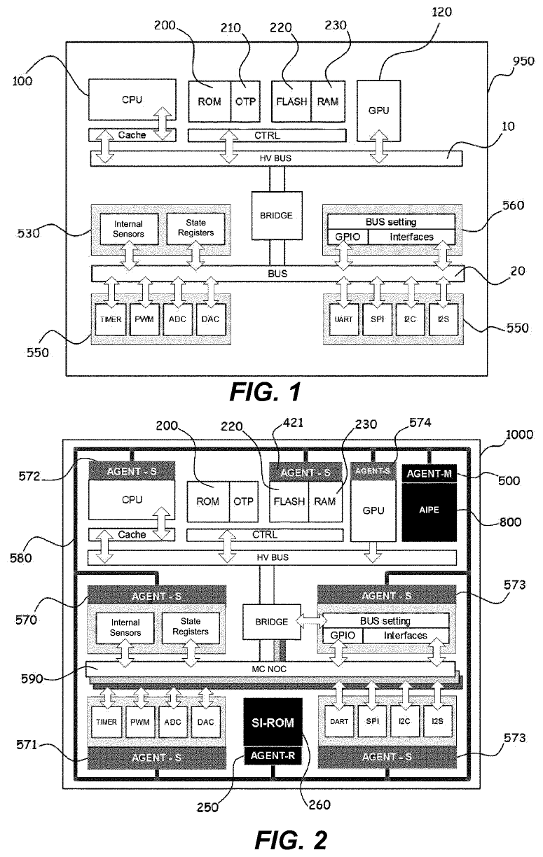

FIG. 1 schematically shows the hardware architecture of a system-on-a-chip (SOC) integrated circuit for implementing the present disclosure. MCU or SOC complex integrated circuits (950) generally incorporate:
one or more microprocessors (100) such as those offered, for example, by INTEL™ or ARM™, also known by the acronym CPU (“central processing unit”);
non-volatile, non-rewritable ROM (200) for recording and reading the boot microcode of the microprocessor (100); once-writable OTP memory (210); rewritable, non-volatile flash memory (220) for storing data that must remain available even if the power supply to the integrated circuit is cut; and RAM (230) for storing calculation variables and data to be processed by the microprocessor (100);
peripheral components, which are an integral part of the integrated circuit and are interconnected by buses (10, 20), such as input/output communication interfaces (560) (e.g., GPIOs, serial buses, 8-bit, 16-bit parallel buses, etc.), as well as peripherals such as UART, I2C, SPI, USB peripherals, but also timers/counters, a controller (PWM) and analog (non-synthesizable) peripherals such as analog-to-digital converters (ADCs), digital-to-analog converters (DACs) that constitute, in conjunction with at least one microprocessor, a SOC or MCU microcontroller unit, which can additionally incorporate a GPU (120), or even a cryptoprocessor, an mpeg2 decoder, interfaces for additional memory (flash or SDRAM), a PCIe or Ethernet interface, etc.; and
a clock generator and reset function are often among the peripherals present in an MCU or SOC. It should be noted that this circuit is not necessarily integrated into the IC, but can be external, in the form of an additional component delivering a signal to one of the input pins of the integrated circuit, or in the form of a quartz crystal connected to the pins of an internal oscillator.

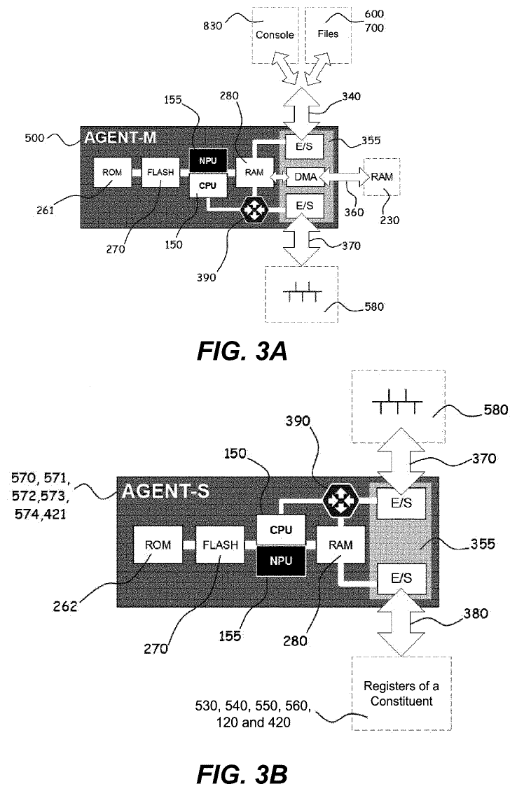

FIG. 2 illustrates the hardware architecture of the integrated circuit, which features five additions to the architecture illustrated in FIG. 1, namely:
1. An information system (260) and its integrated information agent (250)
2. An MAS comprising a packet communication network (580) connecting a plurality of intelligent agents (250, 421, 500, 570 . . . 574), interfaced to their subassemblies
3. A master agent (500) for configuring the integrated circuit and its application program
4. A reconfigurable multilayer network (590), controlled by an agent (573)

5. An assisted interactive programming environment (800) assisted by the master agent (500)

This integrated circuit (1000) starts up in a radically different way from a known integrated circuit (950). Instead of executing an initialization microcode in ROM (200) in the usual way, and then launching an application program recorded in flash (220), for example, the integrated circuit (1000) begins by executing the microcode written in a specific memory (260), according to the present disclosure, in order to activate the information agent (250) prior to any other action in the integrated circuit or SOC.

Firstly, the agent-R (250) queries all of the simplifying agents (421, 570 to 574) via the MAS network (580), in order to dynamically construct a reference database (480) in RAM (230) for the agent-M (500). This database indexes all of the capabilities and parameters of the integrated circuit (1000).

The agent-R (250) will then invoke the agent-S (573) to search for the presence of any integrated circuits of the same type configured in “slave” mode, and connected to the integrated circuit (1000), which in this case will be configured in “master” mode. Where applicable, the database (480) is enriched with all of the capabilities and parameters of each detected “slave” integrated circuit (450).

This database is the entry point for all of the resources of the integrated circuit (1000), which are controlled by the agent-M (500) in order for it to fulfill its function of “overall management of the SOC,” but also so that it controls other interconnected SOCs of the same type, where applicable.

The agent-R (250) then informs the system management agent (500) that the database is fully populated, so that the latter can initialize the SOC with the configuration file (600).

If the “autorun” mode of the integrated circuit or SOC (1000) is activated, the agent-M (500) transmits the file (700) to the agent-S (421) of the application (420), to configure it and launch its execution on the fly. If the SOC is under development, the agent-M (500) waits to receive instructions from the human operator (the coder or developer) via a terminal (900) connected (330) to the AIPE (800).

### Hardware Architecture Making up the Master Agent (500)

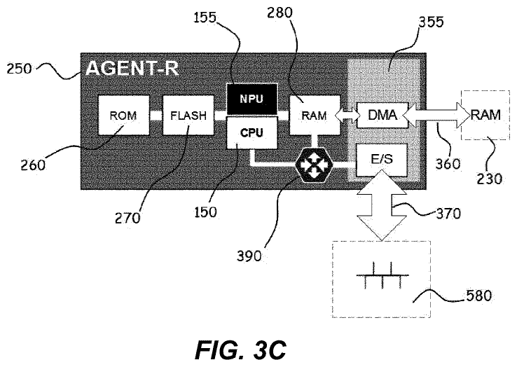

FIG. 3A shows the hardware architecture of the master agent (500), which can equally be described as a “system management agent.”

According to the present disclosure, each agent is made up of a plurality of interconnected hardware components, some of which are common to all types of agent, namely: dedicated memories, and more specifically a read-only memory (260, 261, 262) containing the constituent program of each agent; a non-volatile flash memory (270) containing their database, sometimes integrating a predefined artificial intelligence model; a RAM memory (280) for storing the data used by its CPU (150) and its NPU (155) (NPU=neural processing unit).

In particular, the agent-M (500) has an interface (355) with three bidirectional communication ports. The port (340) receives instructions—either from an operator via the console of a terminal (830)—or from a file (600 or 700). The port (370) is connected to the dedicated network of the MAS (580) in order to address, via the router (390), the simplifying interpreter agents (570 . . . 574, 421) of the subassemblies of the integrated circuit—or else the agent-R (250) operating the information system.

Via the port (360), (DMA=direct memory access), the agent directly accesses the main memory of the SOC (230), in particular, to use the database (480).

### Hardware Architecture Making up a Simplifying Agent

FIG. 3B shows the hardware architecture of a simplifying agent (570 . . . 574, 421), and the following description describes the specific role of each of its components.

In particular, an agent-S (570 . . . 574, 420) has an interface (355) with two bidirectional communication ports. The port (370) is connected to the dedicated network of the MAS (580) in order to dialog with the other agents of the system, which are addressed via the router (390).

The port (380) is connected to the registers of a subassembly of the SOC (530, . . . 560), with which the agent-S is interposed to fulfill its function of interpreter in order to simplify the configuration of the registers of the subassembly, according to the present disclosure.

The non-volatile flash memory (270) stores the lookup table used by the agent-S to establish the link between “the complex programming of many registers to be performed” and the reception of “a simple instruction to be processed,” according to one of the major mechanisms of the present disclosure.

The non-volatile flash memory (270) also contains the predefined artificial intelligence model of the agent-S. The read-only memory (262) contains the constituent program of the agent-S.

The port (380) of the agent-S is also interfaced to the registers of a software component, the application (420) via its API, which is different in nature from the hardware components (410).

### Hardware Architecture Making up the Information Agent

FIG. 3C shows the hardware architecture of the information agent (250), and the following description describes the specific role of each of its components.

In particular, the agent-R (250) has an interface (355) with two bidirectional communication ports. The port (370) is connected to the dedicated network of the MAS (580) in order to dialog with the other agents of the system, which are addressed via the router (390).

Via the port (360), (DMA =direct memory access), the agent directly accesses the main memory of the SOC (230), in particular, to fill in the database (480) that it is responsible for creating, according to the present disclosure.

The non-volatile flash memory (270) stores a directory containing all of the resources of the chip, discovered during its first startup. If resource discovery every time the SOC is started up by the agent-R is deactivated, it uses this directory or “database” to perform its information task. Activation or deactivation of SOC resource discovery on each startup is achieved by applying a bias to the ports (pins, pads, “strapping pins”) of the SOC; the pins (300) will be read by the agent-R (250) on powering up, as described in more detail below.

### Software Architecture

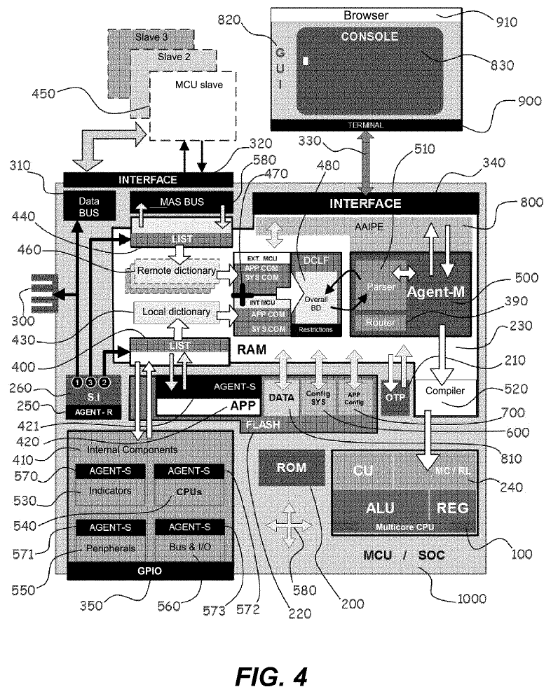

FIG. 4 shows the functional architecture of the integrated circuit according to the present disclosure, which will be better understood by virtue of the following description.

### Step-by-Step Description of how to Initialize the Integrated Circuit, From Power-Up to Operation, According to the Present Disclosure

On starting up the integrated circuit (1000) and before any other action, the information agent (250) is activated by the automatic execution of its program code in dedicated memory (260), which has the effect of launching the tasks of the information system (400, 430, 440, 460, 470, 480).

The first action (260-1) of the agent-R (250) is to read the state of the external configuration pins (300) (strapping pins) to find out (1) whether SOC resource discovery is active, or whether it should read resources from its database stored in memory (270); (2) configure the external port of the data bus (310), the external port of the MAS network (580), the interfaces (320) and (340), and the main interpreter (500), in order to place the integrated circuit in a “master” or “slave” operating mode. The “master” integrated circuit will initiate exchanges and take control of any “slave” integrated circuits (450) that may be connected to its interface (320).

### Querying the Internal Components of the Integrated Circuit and Collecting Their Functions

The second action (260-2) of the agent-R (250) consists in listing (400) the resources of the internal components (410) of the integrated circuit, which are grouped into four categories (non-exhaustive list given as an example):
1. Indicators and measurements (530) of the internal components of the integrated circuit,
2. Configurator (540) for one or more customizable modular CPUs (100),
3. Peripherals integrated into the integrated circuit (550), and
4. Configuration of the buses and network interfaces (590), as well as inputs/outputs (560).

To carry out the listing, the agent-R (250), via its router (390), sends requests to the network of the MAS (580), consisting of a natural language command such as “components.local.detection (address),” designed to scan all of the addresses of the MAS network in order to discover the functional subassemblies of the integrated circuit, marked as 530, 540, 550, 560 in the example shown in FIG. 4.

Each agent-S (570 . . . 573) interposed between the MAS network (580) and the subassembly that it manages will respond with a message containing the identity of the operational components. The agent-R stores the responses in a local dictionary table (430), present in RAM (230).

It then sends a second request to the agents-S (570 . . . 573) of the components that have responded, in order to collect the list of functions of each operational component (530, 540, 550, 560).

These groups of functions addressed to the agent-R by the agents-S are simplified programming commands, listed in human natural language. For example, the agent-S (571) of a sound processing chip has the following list of functions stored in natural language in its flash memory (270), which it transmits to the agent-R operating the information system:
audio.stream. play (On/Off)
audio.volume.adjust (0, 100)
audio.high.adjust (0, 100)
audio.low.adjust (0, 100)
audio.filter.adjust (0, 10)

Purely by convention and by way of non-limiting example, these programming commands take the form of a sequence of words designating (1) the object, (2) its capability or capabilities, (3) the action to be performed, (4) optionally parameters to be transmitted or received.

Behind each of these seemingly simple commands lies a great deal of complexity, which the agent-S will take out of the equation from the point of view of the input operator (or developer). For each of these commands received by the agent-S, a plurality of operations in the registers of the audio chip will be carried out by the agent-S, thereby making a hitherto very complex task for the human operator into a simple and quick task, which instantly triggers the desired result.

These lists of functions transmitted by the agent-S to the agent-R (250) are then sorted, structured, ordered and recorded in RAM (230) by the agent-R, to form a dictionary that lists, for each operational component, its exhaustive list of simplified functions made available to the human operator in natural language (as opposed to symbolic languages).

In this example, it is clear that simply informing the operator of the existence of the “audio.stream.play (On/Off)” command is enough to implement the audio function of the SOC without any other prior knowledge.

The operator no longer needs to study the thousand-page documentation of the audio chip to find the registers involved in this action, let alone the locations of the binary data to be read from or written to the registers. The benefits of the present disclosure are easy to understand.

### Querying the Application Software of the Integrated Circuit and Collecting its Functions

According to an operating mode identical to the process of listing of the internal components (410) specific to the invention, the agent-R executes the second part of the function (260-2), which consists in continuing the listing (400), this time by querying the application (420) recorded in the flash memory (220) of the integrated circuit.

The application (420) is software stored in flash memory (200), which is directly executable by the CPU (100) once loaded into RAM (230), to control the integrated circuit in order to specialize it in performing various tasks, which can operate in multiple fields, such as, by way of non-limiting examples: artificial intelligence for object, animal or human recognition, voice recognition, audio or video processing, surveillance, telecommunications, industrial control robots, etc.

Whatever the field of application, the function of the integrated circuit can, according to the present disclosure, be configured and/or controlled via a list of natural language commands.

To carry out the listing (400) of the application (420), the agent-R (250) sends a request formed by a natural language command, such as “application.description.notifier,” via its router (390) to the agent-S (421) of the application (420) over the MAS network (580). In response, the agent-R (250) receives a message indicating the nature of the application, its unique identifier, its upload date, etc. The agent-R (250) adds this information to the local dictionary (430), then launches a second request to collect the functions of the application in the form of simplified programming commands that are listed in natural language.

The agent-R (250) receives the list of commands made available by the application (420) from the agent-S (421) via the network of the MAS (580). At this stage in starting up the integrated circuit, the agent-R (250) has collected, collated, sorted, structured and added to the local dictionary (430) all of commands for the internal components (410) as well as all of the commands for the application software (420). A metalanguage with a high level of abstraction has thus been dynamically assembled, with the aim of bringing the resources made available by the chip to the attention of the human operator, thereby avoiding the need for them to search for and study them themself, in order to simplify and speed up the programming of the integrated circuit, according to the present disclosure.

Searching for external integrated circuits, and collecting their identities and dictionaries

According to the present disclosure, the third function (260-3) of the agent-R (250) consists in indexing integrated circuits with architectures identical to the master circuit (1000), but configured to operate in “slave” mode (450), possibly interconnected to the interface (320). According to the present disclosure, this interface can be electronic or photonic, i.e., it can use electrons or photons to exchange information with other remote integrated circuits.

In order to carry out the listing (440) with a view to detecting any interconnected slave integrated circuits (450), the agent-R (250) sends an external request over the MAS network (580) of the interface (320). This request consists of a natural language command such as “chip.presence.detect(address),” sent via its router (390) to the agents-M (500) of any potentially connected slave chips (450). Where applicable, the request triggers a response from each of the chips (450) interconnected with the master integrated circuit (1000), which will reveal (1) their unique identifier, (2) the nature of their application determining their function (420).

In the event of a response, the agent-R (250) of the master integrated circuit (1000) will send a second request addressed in turn via its router (390) to the unique identifier of each of the indexed slaves, in order to collect and record, in its RAM (230), a copy of the local dictionaries (430) of the slaves, which will be identified as remote dictionaries (460) in the memory (230) of the master (1000). Next, the agent-R (250) merges (470) its local dictionary (430) with any collected remote dictionaries (460), then organizes and structures the information to dynamically generate the overall database (480).

The overall database (480) thus groups together all of the “internal component” and “application” commands available according to the topology of a system considered as a whole, whether “single-chip” or “multichip,” which can be distributed over one or more interconnected boards, such as a printed circuit board (PCB). This “DCLF” (dynamic construction of simplified programming language functionalities) database (480) reflects the available resources of an infrastructure on each power-up.

To complete its initialization task, the agent-R (250) reads a special register present in its non-volatile flash memory (270), the role of which is to save the operating mode that has been defined, so that the chip works in either “development mode” or in “production mode.”

### Description of the “Programming Mode” of a “Master” Chip

If the autorun function of the integrated circuit is active, the main interpreter (500) is loaded into RAM (230) to be invoked by configuration files (600) and (700), in order to perform batch processing in order to start the integrated circuit or SOC (1000) so that it performs its tasks according to the application (420). A pulse applied to the pins (300) of the chip (1000) will stop the application as it is being run and activate the communication interface (340) in standby mode, so that a connection attempt by an operator will be detected by the integrated circuit (1000). If the autorun function is not active, the communication interface (340) is automatically activated in standby mode, so that a connection attempt by an operator will be detected by the integrated circuit (1000).

### Description of the “Programming Mode” of a “Slave” Chip

If the autorun function of the integrated circuit is active, the main interpreter (500) is loaded into RAM (230) in order to scan the interface (320) in a loop, waiting for requests sent by an interconnected master chip. If the autorun function is not active, the communication interface (340) is activated in standby mode, so that a connection attempt by an operator will be detected by the integrated circuit (1000).

### Description of the “Execution Mode” of a Chip

The main interpreter (500) is loaded into RAM (230) to be invoked by configuration files (600) and (700), in order to perform batch processing in order to start and parameterize the integrated circuit or SOC (1000) so that it performs its tasks according to the application (420). However, a maintenance operator will be able to access the chip (1000) by applying a series of pulses to the pins (300), in order to stop the application as it is being run, and then activate the communication interface (340) in order to access the AAIPE by entering a key encrypted using a complex algorithm, such as “DES” or “AES.”

### Detailed Description of the “System Management Agent,” or “Agent-M”

While the language interpreters of the agents-R or agents-S refer to their database stored in memory (270), the interpreter of the agent-M has the special feature of referring to an external database (480) located in main memory (230), which will have been dynamically constructed by the agent-R (250) beforehand. The parser (510) of the agent-M uses this database (480) to search for and validate by comparison incoming commands that may come from either:
a. input by an operator from a terminal (900);
b. prerecorded entries in files (600, 700) stored in flash memory (220), which are then batch-processed by the interpreter of the agent-M (500). Batch processing is the automatic linking of a sequence of orders (processes) without operator intervention.
c. A request from another agent routed via the network of the MAS (580)
d. An input routed to the interpreter (500) via the interfaces (320, 340,

350)

If there is no match with the database (480), the parser (510) of the agent-M (500) generates an error message such as “order unknown.” If the match is verified, the agent-M routes the order to the address of the agent in question for execution.

A second special feature of the agent-M is its “dual operating mode.” In the above description, the agent-M operates within a decentralized system, where the processing of instructions is distributed over a plurality of networked computers (580) (made up of at least three types of “agent” according to the present disclosure). It can also be considered that the workload is distributed over a plurality of interpreters, which carry out distributed processing of commands.

Conversely, the agent-M (500) has the ability to change language by loading a second database from the flash (220) into memory (230), in order to process commands directly via its “JIT” (“just in time”) on-the-fly compiler (520), to generate a microcode that can be directly executed by the microprocessor unit (100). For example, an application program written in MicroPython can be launched according to a known operating mode.

By displaying the commands in its database (480) by category on a terminal (900), The agent-M considerably speeds up the programming of a specialized integrated circuit (MCU) by an operator with no prior training or knowledge of this type of integrated circuit, in particular, avoiding the tedious step of assimilating a specification manual (datasheet) that can be several thousand pages for an integrated circuit of the prior art (e.g., 9305 pages for the integrated circuit (AM64x/AM243x) Processors Silicon, Revision 1.0, Texas Instruments Families of Products, Technical Reference manual).

### The Intelligent Agent-Assisted Programming Environment

Another fundamental feature of the present disclosure is the integration within the integrated circuit architecture of an assisted programming environment AAIPE (800), which brings together all of the tools required to meet the needs, of the operator, from familiarization—via functions such as programming, simulation, debugging, complete hardware measurement and self-testing—right through to the final functional result.

The system files (810) for this environment are recorded in flash memory (220).

The AAIPE (800) comprises a human-machine interface (820) referred to as a graphical user interface (GUI) displayed by a terminal (900) connected to the communication interface (340). The connection (330) between the interface (340) of the chip (1000) and the terminal (900) of the operator is established via a wired link (e.g., Ethernet) or, in one preferred embodiment, via a wireless radio link. The integrated circuit (1000) includes a Wi-Fi die or, more generally, a radiofrequency die.

The graphical interface (820) is advantageously a web application that can be transmitted to any web browser via the microserver of the AAIPE integrated into the chip (1000). This microserver is accessible via an IP address in “access point” mode for the initial connection, and then in “station” mode after Wi-Fi has been configured for connection to a local network, affording the operator the possibility of accessing the Internet without changing environment, since they is already using their web browser. This gives the operator effortless prior access to a suite of integrated software tools, allowing them to view the documentation, parameterize, configure, program, test and debug the integrated circuit independently, without the need for any additional external devices.

The graphical interface (820) of the AAIPE (800) features a user menu that includes, by way of non-limiting example, some or all of the following tools:
1. A viewer for technical documentation of the integrated circuit, presenting its housing, pinout, wiring diagram of an exemplary chip implementation, a lexicon of simplified commands in natural language that, according to the present disclosure, is reduced to a few dozen pages instead of several hundred.
2. An input console with command prompt (830), which the operator uses to dialog with the management agent-M of the SOC, for example, to ask it to display the commands and parameters of a subassembly of the chip in order to control it instantly. Advantageously, the agent-M autocompletes the input from the operator, and colors the key words of the language commands.
3. A file manager saves and loads “batch files” for instant access to “predefined configuration templates.”
4. An editor capable of handling multiple programming languages to exploit the APIs of the applications (420), or to program an application (420).
5. Electronic design automation (EDA) assisted by remote or embedded artificial intelligence, capable of suggesting, verifying, correcting and simulating the execution of software or hardware configurations (gateware).
6. A system configurator, defining the startup behavior of the chip, optional features, data security and energy savings.
7. A complete device for remote wireless programming of the integrated circuit.
8. A system information, IC self-test and measurement utility.
9. A user account management module, displaying activated functions and the possibility of activating new, optional functions via a micropayment system integrated into the chip.

Beyond the plurality of functions present in the AAIPE (800), its integration at microscopic scale into the core of the integrated circuit (1000) contributes to the implementation of the simplification processes described above, which would be complex or even impossible to achieve according to the known operating modes of a development environment with its suite of tools, such as a plurality of software installed on a host computer, dedicated boards, cables, programmers, simulators, etc.

### Mechanical Part

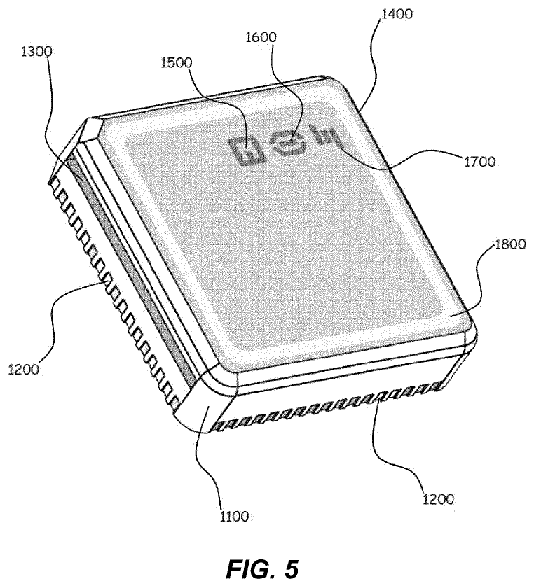

FIG. 5 schematically shows the housing (1100) of the integrated circuit (1000) according to one exemplary embodiment.

The housing (1100) of the integrated circuit (1000) comprises metal pins (1200) and two diametrically opposed lateral attachment grooves (1300, 1400) intended to hold it in a support specifically designed for innovative lateral locking, according to the present disclosure.

Information coded by multicolored light signals is transmitted to the outside world by means of translucent zones (1500, 1600, 1700, 1800) specific to the invention, cut out of the front face of the housing so as to let light pass through, toward which translucent zones the light emitted by four light-emitting diodes belonging to the group of indicators (530) of the internal components (410) of the integrated circuit (1000) is guided.

What is claimed is:

1. A method for programming an integrated circuit comprising one or more microprocessors, at least one random-access memory, at least one read-only memory and at least one non-volatile rewritable memory, at least one high-speed bus and one bus, and functional components, consisting in recording, in the non-volatile rewritable memory, a set of executable computer codes, the method comprising booting steps according to an execution mode or according to a programming mode,
wherein the method further comprises:
an original step of recording, in a non-erasable mass memory of the integrated circuit, during the manufacture of the integrated circuit,
a set of static resources comprising the digital development tools forming an assisted development environment executable by a browser and the technical documentation relating to the programming of the integrated circuit,
and a boot code according to a programming mode,
the booting step according to the programming mode consists in controlling,
querying the state of the hardware and software dynamic resources of the integrated circuit and a step of recording, in a local rewritable memory, the state for each of the hardware and software resources, and
activating the transfer of the static resources and the dynamic resources to a connected external computer device.

2. The method of claim 1, wherein the querying step also comprises querying the state of resources of the connected electronic environment of the integrated circuit, which are also recorded in the local rewritable memory.

3. The method of claim 1, wherein, when the integrated circuit is powered up, the booting step is activated according to the programming mode either when the memory for recording the files transferred by the external computer device is blank, or when a reference voltage is applied to a pin of the integrated circuit, and wherein otherwise the booting step is activated according to the execution mode.

4. The method of claim 1, wherein the querying step comprises, for each of the resources, recording in the memory:
a. at least one numerical descriptor for each of the resources, and
b. a list of simplified programming commands for each of the resources.

5. The method of claim 1, wherein the booting step, according to the programming mode, further controls:
I. Transmission, to a connected terminal by an integrated development environment, of a web application executable by the browser of the terminal, the web application comprising:
technical documentation and the specifications for the integrated circuit, and
a specific programming software suite for the integrated circuit;
II. Transmission, to the connected terminal, of the list of simplified programming commands for each of the resources.

6. The method of claim 1, wherein the booting step, according to the execution mode, controls the loading of a system configuration file and of an application configuration file, recorded in the non-volatile memory, which comprise a list of interpretable commands, the presence of each of the commands in the local database being checked in order to be compiled and executed on the fly.

7. The method of claim 1, wherein the initial step further comprises reading the pin state of the integrated circuit to determine:
a. an execution mode or a programming mode;
b. a “master” mode or a “slave” mode, and, in the case of the master mode, collecting the contents of the local databases of the interconnected “slave” integrated circuits; and
c. activating the discovery of the resources of the integrated circuit on each startup.

8. An integrated circuit comprising one or more microprocessors, at least one random-access memory, at least one read-only memory and at least one rewritable non-volatile memory, at least one high-speed bus and one bus, and a set of functional components, a communication circuit for communicating with a connected external computer device, the communication circuit comprising a router and a plurality of interfaces for exchanging data and an interface for exchanging data with a connected peripheral terminal and for accessing the programs and data recorded in the rewritable non-volatile memory, the non-erasable mass memory of the integrated circuit, during the manufacture of the integrated circuit,
a. a set of static resources comprising the digital development, simulation and test tools forming an artificial intelligence-assisted development environment executable by a browser and the technical documentation relating to the programming of the integrated circuit,
b. and a boot code according to a programming mode.

9. The integrated circuit of claim 8, further comprising;
a plurality of agents each consisting of a computer each comprising a processor, an artificial intelligence accelerator microprocessor, a read-only memory, a non-volatile memory, a random-access memory, a router and a plurality of interfaces for data exchange;
a bus for data exchange between the agents;
one of the agents being an information agent-R comprising:
an interface for direct access to the RAM, and
an interface for data exchange with a bus;
others of the agents being simplifying agents-S;
comprising an interface for data exchange via the bus with the plurality of agents;
comprising an interface for data exchange with each of the functional components and for data exchange with a software application;
one of the agents being a master agent-M comprising:
an interface for data exchange via the bus with the plurality of agents, and
an interface for data exchange with a connected peripheral terminal and for accessing the programs and data recorded in the rewritable non-volatile memory.

10. The integrated circuit of claim 9, further comprising configuration pins for controlling the state of the information agent-R by applying a voltage.

11. The integrated circuit of claim 9, further comprising a non-volatile memory containing:
a first microcode, the execution of which controls the search, collection, processing and storage of data relating to each subassembly of the integrated circuit;
the first microcode automatically generating requests routed to internal components via at least one bidirectional configuration bus,
these requests triggering responses by the internal components and peripherals that are available and operational in the integrated circuit, the responses being processed in order to construct a database identifying the internal resources and peripherals and listing their respective simplified commands in the database, and
the execution of the first microcode being controlled during startup by writing, into a register in the boot read-only memory of the agent-R, a code defined by the polarity of one or more external pins dedicated to the initial configuration.

12. The integrated circuit of claim 11, wherein the boot read-only memory of the agent-R further comprises a register the state of which indicates whether the execution mode or the programming mode is selected, and further a register the state of which indicates whether the MCU is designated as master or slave, depending on the polarity of one or more external pins dedicated to the initial configuration.

13. The integrated circuit of claim 12, wherein the subassemblies of the integrated circuit are each associated with an autonomous agent comprising ROM, FLASH and RAM memories, a microprocessor, an artificial intelligence accelerator microprocessor, an input/output interface, a natural language microinterpreter, and a table containing the attributes and functionalities of the subassembly associated with the agent.

14. The integrated circuit of claim 13, wherein the non-volatile memory further comprises a second microcode controlling the querying of the communication buses for the presence of one or more slave additional integrated circuits and, where applicable, searching for and importing the command tables for each of the slave integrated circuits, and recording, in a second command table, the second command interpreter microcode ensuring, in response to a natural language request transmitted either by the remote terminal or by reading a file recorded in the memory, the querying of the local command table and, failing that, the querying of the second command table, in order to ensure the configuration of the registers associated with the function corresponding to the interpreted command, according to the arguments of the request, where applicable.

15. The integrated circuit of claim 8, wherein the database comprises information coded in natural language and communicates with the communication interface on the one hand, and a binary code interpreter executing the actions ordered by the instructions in the language on the other hand.

16. The integrated circuit of claim 9, wherein the database comprises an information system associated with an information agent, a packet communication network connecting a plurality of intelligent agents, each interfaced to their subassemblies, a master agent for configuring the integrated circuit and its application program, a reconfigurable multilayer network controlled by an agent, and an interactive programming environment assisted by the master agent, AAIPE.
